(19) United States
(12) Patent Application Publication
(10) Pub. No.: US 2007/0065765 A1
(43) Pub. Date: Mar. 22, 2007

(54) Energy converting device

(76) Inventor: Hans-Peter Bierbaumer, Rohr/Kremstal (AT)

Correspondence Address: WILLIAM COLLARD;COLLARD & ROE, P.C., 1077 NORTHERN BOULEVARD, ROSLYN, NY, 11576, US

(21) Appl. No.: 10/575,791

(22) PCT Filed: Oct. 6, 2004
(86) PCT No.: PCT/AT04/00341

§ 371 Date: May 19, 2006

(30) Foreign Application Priority Data
Oct. 14, 2003 (AT) A 1618/2003

(51) Int. Cl. C10L 1/12

(52) U.S. Cl. 431/2

(57) ABSTRACT

The invention relates to a device for converting energy comprising a gas generator (6) for generating a hydrogen-oxygen mixture or Brown gas with a reaction chamber (19) in which electrodes (29) are disposed. The reaction chamber (19) is of a rotationally symmetrical shape with respect to an axis (18) and at least certain regions of inner boundary surfaces (20) of the reaction chamber (19) in the region of a jacket (21) of the reaction chamber (19) are formed by inner electrode surfaces (30, 31) of the electrodes (29) of the gas generator (6).

The invention relates to a device and a method for converting energy, incorporating a gas generator for generating a hydrogen-oxygen mixture or Brown gas, of the type having the features outlined in the introductory parts of claims 1 and 23.

Document U.S. Pat. No. 6,443,725 B1 already discloses a heating device and a method of generating heat, based on the cyclical combustion of Brown gas. Brown gas is produced from water in a so-called Brown gas generator using a special form of electrolysis. Due to the electrolytic treatment of the water in the Brown gas generator, it is transformed into a special state and consists of a mixture of dissociated hydrogen and oxygen atoms. As specified in U.S. Pat. No. 6,443,725 B1, the Brown gas is delivered to a combustion chamber where it is converted back into water molecules after combustion. The water molecules are then ionised to produce hydrogen and oxygen by absorbing infrared radiation.

Document U.S. Pat. No. 4,014,777 A discloses devices and a method for producing hydrogen and oxygen in the form of Brown gas. This Brown gas is then used for welding or soldering. In one embodiment of a Brown gas generator, an electrolysis cell is described as having serially connected electrode plates. These electrode plates are secured to tubes made from insulating material, and openings of the tubes are provided between respective adjacent electrodes. The electrodes are placed in electrical contact, in the end region of the tubes, with an external power supply. The tubes incorporating the electrodes are immersed in a solution of water and KOH. Through the orifices in the tubes, solution is able to penetrate between the electrodes, on the one hand, and the resultant gas is able to leave the space between the electrodes, on the other hand. The advantage which this device has over conventional gas welding apparatus is that hydrogen and oxygen are automatically produced in the correct ratio, enabling a neutral flame to be generated.

The objective of the invention is to propose a device and a method for converting energy using a hydrogen-oxygen mixture or Brown gas, by means of which a high degree of efficiency can be achieved. Another objective of the invention is to achieve increased productivity when generating the hydrogen-oxygen mixture or Brown gas.

This objective is achieved by the invention on the basis of the device for converting energy incorporating the characterising features defined in claim 1. The advantage of this device resides in the fact that a higher degree of efficiency can be achieved because the rotationally shaped design of the reaction chamber of the gas generator permits the simultaneous intervention of an electric field and a rotating motion on the working medium or water, which is conducive to the formation of Brown gas and increases the rate at which it forms as a result.

Also of advantage is another embodiment in which at least one inlet connector for the working medium oriented a tangent to the jacket of the reaction chamber is provided in the jacket of the reaction chamber, because the working medium is displaced in rotation solely due to the movement of the working medium as it flows into the reaction chamber.

In the case of other embodiments of the device for converting energy, a rotor with a rotation axis is provided in the gas generator, oriented coaxially with the axis of the rotation chamber, and the rotor is designed to generate a rotation with an angular velocity in the range of 10 s⁻¹to 25 s⁻¹, the advantage of which is that a force can be applied which is concentrated so that it acts on the bubbles of Brown gas as they form in the direction towards the axis of the reaction chamber.

Another embodiment of the device for converting energy is provided with an outlet orifice in one of the base plate and/or cover plate closing off the reaction chamber, which is disposed coaxially with the axis of the reaction chamber, the advantage of which is that Brown gas forming in the region of the axis of the reaction chamber can be easily drawn off through this outlet orifice.

In one embodiment, the outlet orifice is formed by a suction lance which can be displaced parallel with the direction of the axis of the reaction chamber, the advantage of which is that it minimises the degree to which the working medium is undesirably sucked out with the Brown gas which has formed in the reaction chamber because the immersion depth of the suction lance can be adjusted accordingly so that the outlet orifice can be fed as close as possible past the site where the Brown gas is being generated.

The advantage of the device for converting energy provided with an acoustic source or in which the acoustic source generates sound at a frequency in a range of 25 kHz to 55 kHz, preferably 38.5 kHz to 41.5 kHz, even more preferably 40.5 kHz, is that applying sound to the working medium increases the rate at which the Brown gas forms.

Also of advantage are embodiments of the device in which the acoustic source is disposed coaxially with the axis of the reaction chamber or at least a part-region of the inner boundary surface of the reaction chamber is formed as a reflector which concentrates the sound, because the sound can be concentrated in the region of the axis as a result and the acoustic pressure can be increased in the region of the axis.

Also of advantage is the embodiment of the device in which the gas generator is provided with an infrared source, because exposing the working medium to infrared radiation likewise has a positive effect on the formation of Brown gas and the formation of Brown gas is accelerated.

In another embodiment of the device for converting energy, the gas generator is provided with a magnet and the magnetic field direction of the magnet in the region of the axis of the reaction chamber is oriented anti-parallel with respect to the direction of the angular velocity of the rotor or the rotating motion of the working medium in the reaction chamber, the advantage of which is that the separation of molecular oxygen and molecular hydrogen is suppressed at the two electrodes in favour of generating Brown gas. Due to the rotating movement of the working medium in the magnetic field of the magnet with an anti-parallel positioning of the magnetic field direction with respect to the angular velocity of the rotating motion of the working medium, a resultant force can effectively be applied to ions in the working medium by the magnetic field which forces the ions on a spiral path of motion extending in the direction towards the axis of the reaction chamber. This prevents the ions from moving close to the electrodes, where they would otherwise separate.

The advantage of the embodiment of the device for converting energy with a pressure vessel for the working medium is that the pressure of the working medium in the device can be set to an optimum level, which is conducive to the rate at which Brown gas forms.

Also of advantage is the embodiment of the device for converting energy in which it is provided in the form of a heating device incorporating a heat generator and the interior of the heat generator is provided or filled with a sintered material or sintered metal, because the recombination or conversion into water during which no naked flame is formed takes place relatively slowly as the Brown gas flows through this sintered material.

In another embodiment of the heating device, the gas generator, the heat generator, the heat exchanger, the pressure vessel and the pump are connected to one another forming a closed circuit for the working medium, the advantage of which is that the working medium can remain in the circuit and there is no need to dispose of waste water or residues. In particular, this prevents any electrolytes introduced into the working medium from gradually being depleted or lost.

In another embodiment of the heating device, a fan is disposed on the heat exchanger for feeding heat away from the heat exchanger to the ambient environment, the advantage of which is that the amount of heat emitted can be controlled by varying the quantity of air flowing past the heat exchanger.

In another embodiment, the device for converting energy has a control device for controlling the operating mode, the advantage of which is that all the parameters of the individual components of the device can be set centrally.

Also of advantage is the embodiment of the control device which operates controls on an automated or programmed basis, because the operating mode can be adjusted and in particular adjusted subsequently on an automated basis to produce an optimum yield of heat and form Brown gas automatically in the gas generator.

The objective of the invention is also independently achieved by the method of converting energy using a hydrogen-oxygen mixture or Brown gas incorporating the characterising features defined in claim 23. The advantage of this approach is that a higher degree of efficiency can be achieved with this method.

In one embodiment of the method, the water and/or Brown gas is exposed to a magnetic field in the reaction chamber, whereby the magnetic induction in the region of the axis of the reaction chamber is oriented anti-parallel with respect to the direction of the angular velocity, the advantage of which his that a force can be directed by the magnetic field onto the ions disposed in the rotating working medium in the direction towards the axis of the rotating motion, thereby promoting the formation of Brown gas in the region of the axis of the rotating motion of the working medium.

In another embodiment of the method, the water and/or Brown gas is exposed to acoustic energy in the reaction chamber or the water and/or Brown gas in the reaction chamber is exposed to infrared radiation, the advantage of which is that the rate at which Brown gas is formed increases.

Also of advantage is another embodiment of the method, whereby the water and Brown gas are conveyed in a closed circuit, because there is no need to disposed of residues, on the one hand, and electrolytes introducing into the working medium or water are not depleted, on the other hand.

The rate at which Brown gas forms can also advantageously be increased by periodically varying the angular velocity of the rotation of the water in the reaction chamber or the pressure of the working medium in the circuit or the acoustic intensity of a acoustic source. This is also assisted by the fact that the periodic variation of the pressure of the working medium takes place in opposite phases with respect to the periodic variation in the acoustic intensity of the acoustic source and the value of the frequency of the periodic variation in the pressure of the working medium and/or acoustic intensity of the acoustic source and/or the angular velocity is selected from of a range of between 0.1 Hz and 10 Hz.

Also of advantage is another embodiment of the method, whereby the recombination of the hydrogen-oxygen mixture or Brown gas into water takes place in a heat generator, in which case the heat created by the heat generator is fed away with the water, thereby obviating the need for a separate medium to transport the heat.

In another embodiment of the method, the Brown gas is fed through a sintered material in the heat generator, the advantage of which is that flames are prevented from forming during recombination of the Brown gas to water and the transformation of the Brown gas into water takes place relatively slowly.

To provide a clearer understanding, the invention will be explained in more detail below with reference to the appended drawings.

The schematically simplified diagrams of the drawings illustrated the following:

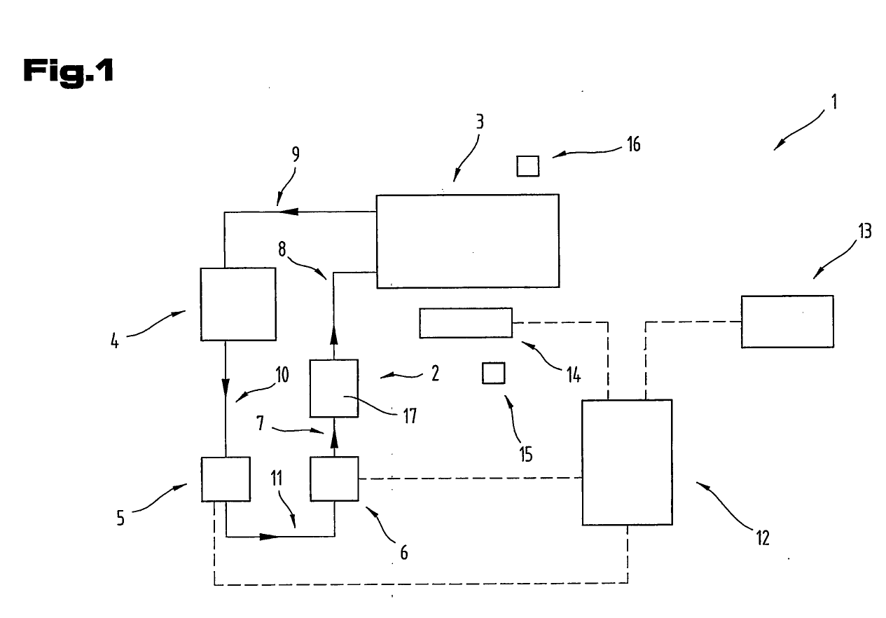

FIG. 1 a system diagram of a heating device, illustrated in the form of a block diagram of an air heating system;

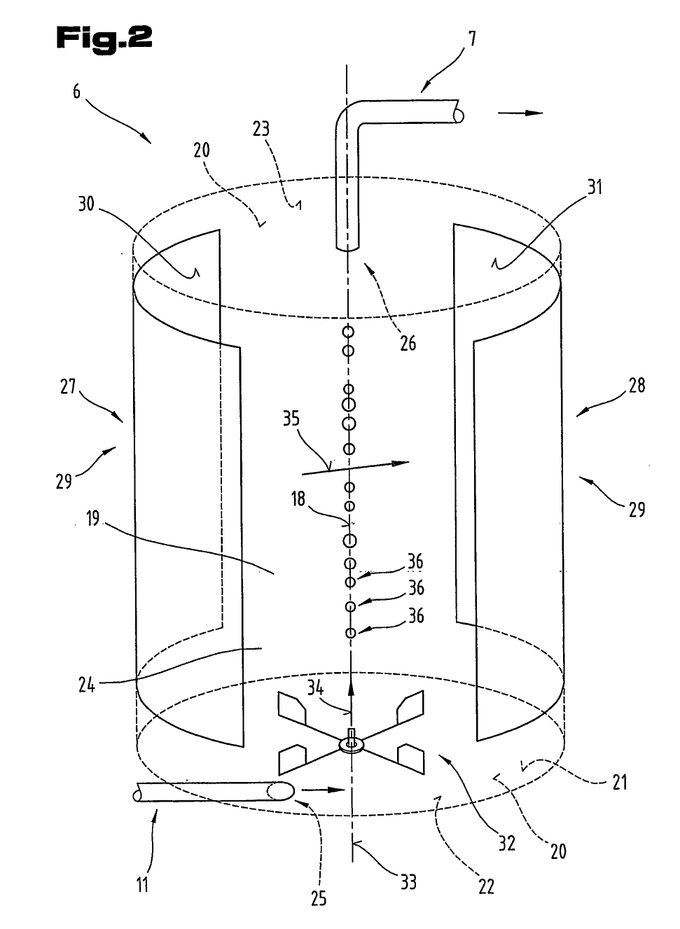

FIG. 2 the schematically illustrated structure of the gas generator as a detail of the heating device;

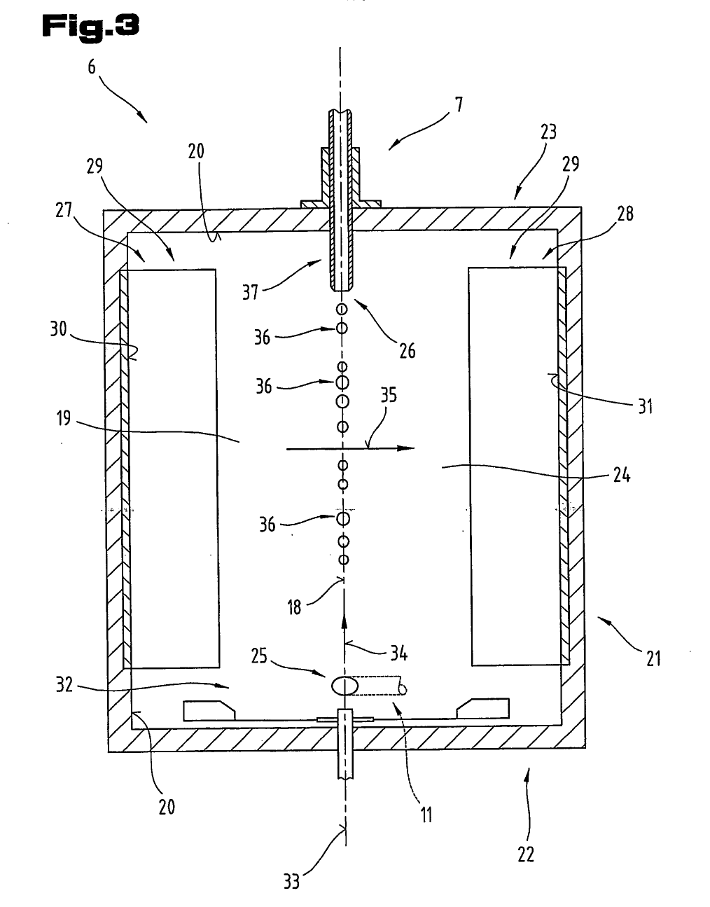

FIG. 3 a section illustrating another example of an embodiment of a gas generator of a heating device with a cylindrical reaction chamber;

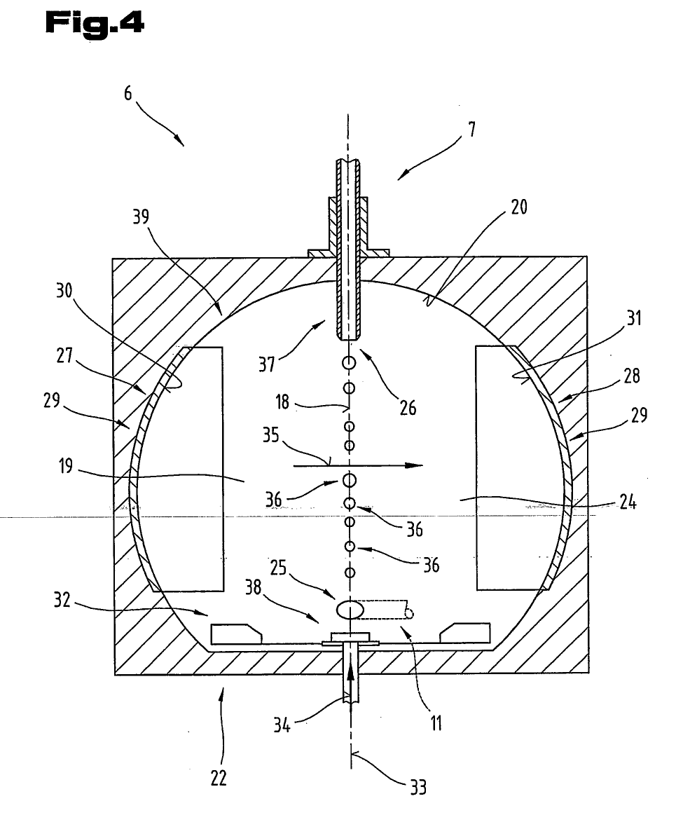

FIG. 4 an example of an embodiment of the gas generator of the heating device with an acoustic source disposed in the reaction chamber;

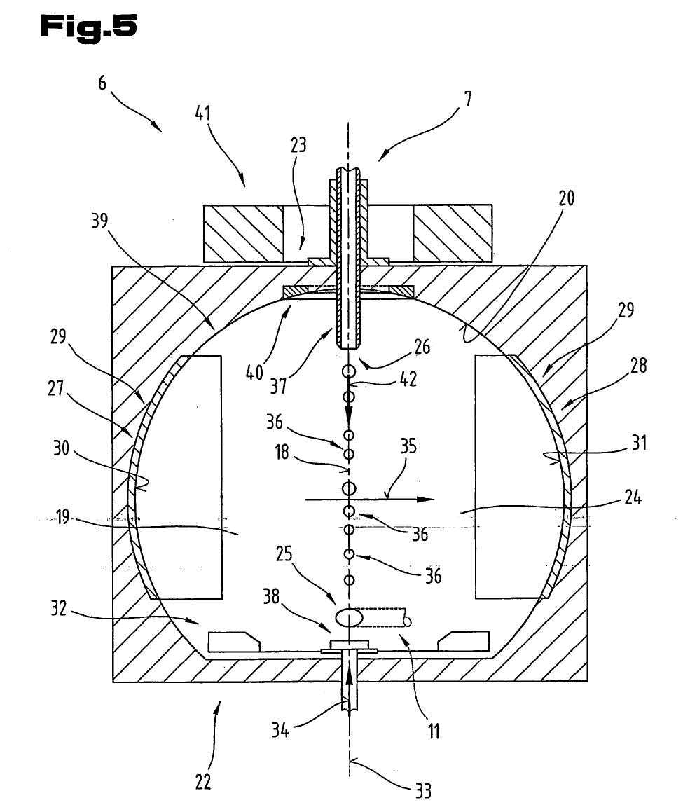

FIG. 5 an example of another embodiment of the gas generator of the heating device with an infrared source and a magnet;

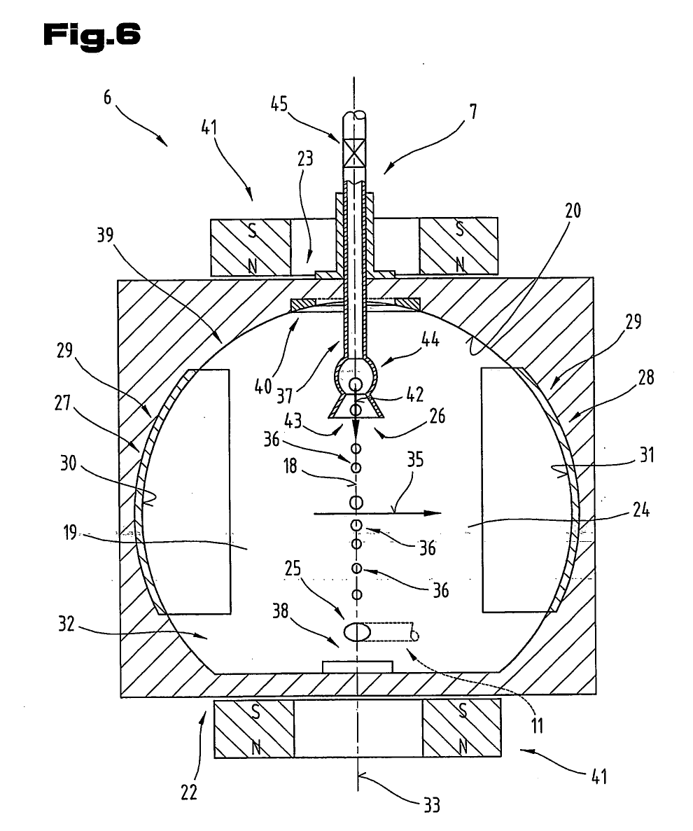

FIG. 6 an example of another embodiment of a gas generator.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc, relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 is a system diagram illustrating a heating device 1, in the form of a block diagram of an air heating system.

The heating device 1 represents an example of a device for converting energy, on the basis of which the invention will be explained in more detail below.

A heat generator 2, a heat exchanger 3, a pressure vessel 4, a pump 5 and a gas generator 6 are connected to one another to form a closed circuit for a working medium. Water is used as the working medium and is converted into a hydrogen-oxygen mixture or Brown gas in the gas generator 6. The Brown gas arrives via a line in the heat generator 2, where heat is generated by converting the Brown gas into water, which is then transported with this water via a line 8 into the heat exchanger 3. Heat is discharged to the ambient air by this heat exchanger 3, thereby reducing the temperature of the working medium and the water accordingly. Via a line 9 between the heat exchanger 3 and the pressure vessel 4, a line 10 between the pressure vessel 4 and the pump 5 and finally a line 11 between the pump 5 and the gas generator 6, the cooled water is returned to the gas generator 6. The heating device 1 also has a network device 12 for supplying electrical energy and a control system 13. The process of dissipating heat to the ambient air by the heat exchanger 3 can additionally be regulated by means of a fan 14. To this end, the temperature of the inflowing air is measured by a temperature sensor 15 and that of the discharged heated air is measured by a temperature sensor 16. The total quantity of heat discharged to the ambient air as a whole can be determined on the basis of the volume or quantity of air fed through the heat exchanger and the temperature difference between the two temperature sensors 15, 16. In order to detect the temperatures measured by the temperature sensors 15, 16 and in order to activate and control the fan 14, the latter are connected to the control system 13 and the corresponding adjustments can be made on an automated basis or under the control of a programme. The pump 5, pressure vessel 4 and gas generator 6 are likewise connected to the control system 13. In order to provide greater clarity, the appropriate signal lines between the control system 13 and the individual components of the heating device 1 have been omitted from FIG. 1.

In an embodiment given as a first example, the interior of the heat generator 2 is filled with an open-pored sintered material 17 or a sintered metal. The Brown gas is delivered via line 7 into the heat generator 2 and undergoes a catalytically induced recombination or conversion into water on the very large surface area of the inner pores of the sintered material 17. As the hydrogen-oxygen mixture or Brown gas is converted into water, heat is released and is transported with the resultant water as a heat storage or energy carrier via line 8 into the heat exchanger 3. The advantage of this is that recombination of the Brown gas to water takes place relatively slowly in the sintered material 17 and without the formation of flames.

In another example of an embodiment of the heating device 1, the heat generator 2 is provided in the form of a combustion chamber, in which case a flame trap (not illustrated) is provided between line 7 and the heat generator 2. In order to initiate the combustion process in the heat generator 2, the latter is also equipped with an ignition device (not illustrated).

FIG. 2 provides a schematic diagram of the structure of the gas generator 6 as a detail of the heating device 1.

The interior of the gas generators 6 is provided in the form of a reaction chamber 19 of a rotationally symmetrical shape with respect to an axis 18. In order to improve clarity, the outer boundary surfaces 20 of this reaction chamber 19 are merely indicated by broken lines. In the embodiment illustrated as an example here, the reaction chamber 19 is of a cylindrical shape and the boundary surfaces 20 are formed by a jacket 21 and a disc-shaped base plate 22 as well as a cover plate 23, which is likewise disc-shaped.

A working medium 24 essentially comprising water is delivered via line 11 to the reaction chamber 19, and an inlet connector 25 of the line 11 or inlet orifice to the reaction chamber 19 is oriented at a tangent with respect to the axis 18. An outlet orifice 26 of the reaction chamber 19 merging into the line 7 is disposed or oriented coaxially with respect to the axis 18 of the reaction chamber 19. Disposed on the jacket 21 of the reaction chamber 19 are two electrodes 29 constituting an anode 27 respectively a cathode 28 and inner electrode surfaces 30 respectively 31 constitute at least certain regions of the boundary surface 20 in the region of the jacket 21 of the reaction chamber 19. In other words, the boundary surface 20 in the region of the jacket 21 merge constantly with the inner electrode surfaces 30 respectively 31 and these surfaces therefore jointly form a cylindrical jacket surface. This prevents turbulence from being generated in the working medium 24 as the working medium flows past the edges of the electrode surfaces 30 respectively 31. The working medium 24 is effectively displaced in rotation or a rotating motion by means of a rotor 32. The rotor 32 is disposed in the region of the base plate 22 and has a rotation axis 33 oriented coaxially with the axis 18 of the reaction chamber 19. The rotating motion of the rotor 32 is effected at an angular velocity 34, the vectorial direction of which 34 is oriented parallel with the axis 18 of the reaction chamber 19 in the direction towards the cover plate 23. In the region of the casing 21, therefore, the working medium flowing out of the inlet connector 25 at a tangent moves in the same direction as the working medium moving in rotation in the reaction chamber 19, which prevents turbulence from being created in the working medium in the region of the inlet connector 25. The rotor 32 and a motor driving it are designed so that the rotation is effected at an angular velocity 34 in a range of 10 sec⁻¹ to 25 sec⁻¹.

When an electric voltage is applied to the electrodes 29, an electric field 35 is generated between the anode 27 and the cathode 28, causing a corresponding movement of the ions present in the working medium 24 so that molecular oxygen is formed at the anode 27 and molecular hydrogen is formed at the cathode 28 as a result. This separation of oxygen and hydrogen takes place on the basis of the usual electrolytic splitting of water at the electrode surfaces 30 respectively 31. It is known that Brown gas, which is a specific form of electrolytically modified water, is formed in the middle between the two electrodes 29 and therefore accumulates in the region of the axis 18 of the reaction chamber 19 in the form of bubbles 36. The bubbles 36 of Brown gas formed are concentrated in the region of the axis 18 of the reaction chamber 19 due to the rotating movement of the working medium 24 and also rise due to the uplift in the reaction chamber 19, in the direction towards the outlet orifice 26 and can therefore be easily sucked through the line 7. As a result of the rotating motion of the working medium 24 generated in the reaction chamber 19 with the aid of the rotor 32, a force acts on the bubbles 36 of Brown gas as they form, which also causes them to be concentrated in the region of the axis 18 of the reaction chamber 19 and enables the resultant Brown gas to be sucked through the outlet orifice 26 and line 7 out of the reaction chamber 19. On the other hand, however, the rotating flow of the working medium also causes the ions to diffuse and move in the direction towards the electrodes 29 and undergo a constant deflecting motion depending on the direction of the electric field 35, thereby preventing and suppressing a separation into molecular oxygen and molecular hydrogen at the electrodes 29, as a result of which the formation of Brown gas in the bubbles 36 is promoted. The yield of this Brown gas generated in the gas generator 6 is significantly improved as a result.

FIG. 3 illustrates an example of another embodiment of a gas generator 6 of a heating device 1 with a cylindrical reaction chamber 19.

The electrodes 29 are embedded in the internal face of the jacket 21 of the reaction chamber 19 so that the inner electrode surfaces 30 respectively 31 form a cylindrical surface in conjunction with the inner boundary surface 20 of the reaction chamber 19. The base plate 22, the cover plate 23 and the jacket 21 bounding the reaction chamber 19 are made from a material that is not electrically conductive, preferably a plastic.

The outlet orifice 26, which extends into line 7, is again disposed coaxially with respect to the axis 18 of the reaction chamber 19 in the region of the cover plate 23. In addition, in this case, the outlet orifice 26 is provided in the form of a suction lance 37 in the front end region. This suction lance 37 can be displaced in the direction parallel with the axis 18 of the reaction chamber 19 and can therefore be inserted to differing degrees in the reaction chamber 19. The suction lance 37 can be positioned accordingly so that only a very low proportion of the working medium 34 is sucked along with the bubbles 36 of Brown gas. As explained above, the working medium 24 is introduced into the reaction chamber 19 through the inlet connector 25 and is displaced by the rotor 32 in a rotating motion at an angular velocity 34. The simultaneous effect of the electric field 35 and the rotating motion at the angular velocity 34 causes Brown gas to form in the bubbles 36, which is sucked away from the region of the axis 18 of the reaction chamber by means of the suction lance 37.

FIG. 4 illustrates an example of an embodiment of the gas generator 6 of the heating device 1 with an acoustic source 38 disposed in the reaction chamber 19.

The acoustic source 38 is disposed coaxially with respect to the axis 18 of the reaction chamber 19 in the region of the base plate 22. In the embodiment illustrated as an example here, the acoustic source 38 is also mounted on the rotor 32. This acoustic source 38 emits ultrasound into the reaction chamber 19 at a frequency in a range of 25 kHz to 55 kHz, preferably 38.5 kHz to 41.5 kHz, to which the working medium 24 is therefore exposed. A frequency of 40.5 kHz has proved to be particularly expedient. In addition to providing the acoustic source 38 in the reaction chamber 39, the inner boundary surfaces 20 of the reaction chamber 19 are also formed by a curved surface in the direction parallel with the axis 18 and in the embodiment illustrated here by a spherical surface. In other words, at least a part-region of the inner boundary surfaces 20 of the reaction chamber 19 is formed by a reflector 39 which concentrates the sound. The inner electrode surfaces 30 respectively 31 therefore also constitute part-regions of the reflector 39. The spherically shaped reflector 39 in conjunction with the acoustic source 38 in the region of the axis 18 has the effect of concentrating the sound, and the sound pressure is increased or concentrated in the region of the reaction chamber 19 across the length of the axis 18. Since the reflector 39 is not parabolic in shape, the sound is not concentrated on an individual point or combustion point but is concentrated across an extended longitudinal region of the axis 18 in the reaction chamber 19. However, this longitudinal region of the axis 18 is also the region in which the Brown gas can be observed forming in the bubbles 36. It has been found that the fact of exposing the working medium 24 and the region in which the bubbles 36 form to sound in the area around the axis 18 results in a significant increase in the formation of Brown gas.

Although it is not absolutely necessary to mount the acoustic source 38 on the rotor 32 and drive it in rotation therewith, it nevertheless of advantage in situations where the acoustic source 38 does not have a rotationally symmetrical emission characteristic with respect to the axis 18, because the rotating movement with the rotor 32 results in a timed transmission or uniform distribution in terms of the spatial distribution of the acoustic pressure over and above each respective revolution of the rotor 32.

FIG. 5 illustrates another example of an embodiment of the gas generator 6 of the heating device 1 with an infrared source 40 and a magnet 41.

The infrared source 40 is recessed in the boundary surface 20 in the region of the cover plate 23 and emits infrared radiation into a region of the reaction chamber 19. Exposing the working medium 24 to infrared radiation has also been found to promote the formation of Brown gas in the bubbles 36 and is therefore able to accelerate formation of the Brown gas. The point in the reaction chamber 19 at which the infrared source is disposed is not decisive in terms of the effect produced. The essential factor is that the working medium 24 is exposed to infrared radiation as such.

The magnet 41 is likewise disposed in the region of the cover plate 43 and is oriented so that the magnetic induction 42 in the region of the axis 18 of the reaction chamber 19 is anti-parallel with respect to the angular velocity 34 or with respect to its direction. The combined effect of rotating the working medium 24 by means of the rotor 32 and the electric field 35 causes ions in the working medium 24 to be moved in more or less circular trajectories. Depending on the force exerted on charges moved in magnetic fields caused by the magnetic field, the magnetic induction oriented anti-parallel with respect to the angular velocity 34 causes an additional force which is directed more or less in the direction towards the axis 18 of the reaction chamber 19. The effect of this additional force causes the ions in the working medium 24 to be forced along spiral paths, which become ever closer to the axis 18 of the reaction chamber 19. The force from the magnet 41 therefore has the effect of moving the ions in the working medium 24 onto the anode 27 and onto the cathode 28, where they cause the formation of molecular oxygen and molecular hydrogen and also cause the ions to be concentrated in the region of the axis 18, where the formation of Brown gas in the bubbles 36 is rendered more intensive as a result.

A method of generating heat with Brown gas can therefore be operated by means of the heating device 1. To this end, the working medium 24 or water is firstly introduced into a reaction chamber 19 of a rotationally symmetrical shape with respect to the axis 18, and an electric field 35 is applied with the electric field direction oriented perpendicular to the axis 18 of the reaction chamber 19, and the working medium 24 or water is displaced in rotation. The rotation axis of the water is oriented coaxially with the axis 18 of the reaction chamber 19. This means, on the other hand, that the direction of the electric field 35 is oriented perpendicular to the rotation axis of the water. In another step, the Brown gas is fed out of the working medium 24 or water in the reaction chamber 19 under the effect of the electric field 35 and the rotation in the reaction chamber 19 and is then recombined to water in a heat generator 2, giving off heat as a result of this exothermic process. The water formed in the heat generator 2 is preferably also used as a medium for transporting heat and the resultant heat is therefore transported with this water or working medium 24 into the heat exchanger 3. From the heat exchanger 3, the working medium 24 or water passes via the pressure vessel 4 and the pump 5 back into the gas generator 6, where it is available for the formation of Brown gas again. The working medium 24 or water is therefore circulated in a closed circuit.

With the aid of the pressure vessel 4, the pressure of the working medium 24 can be regulated within the circuit. The flow rate of the working medium 24 in the circuit is determined by the pump 5, which determines the rate at which Brown gas is formed accordingly. The pump work rate is set precisely so that, as far as possible, only the resultant Brown gas is fed out of the gas generator 6 via the line 7. The proportion of working medium 24 fed into the line with the Brown gas is kept as low as possible. The various parameters determining the operating mode of the heating device 1 are preferably set by the control system 13 under the control of a programme.

The process of forming the Brown gas in the gas generator 6 of the heating device 1 preferably takes place in conjunction with the additional effect of acoustic energy, which acts on the working medium 25 in the form of ultrasound emitted by an acoustic source 38. By preference, the Brown gas is also formed under the effect of a magnetic field from a magnet 41 or of infrared radiation from an infrared source 40. The sound pressure from the acoustic source 38 as well as the intensity of the infrared radiation from the infrared source 40 and the magnetic induction 42 of the magnet 41 are set by the control system 13, preferably under the control of a programme.

It has also been found that the level of efficiency of the method for generating heat with Brown gas can be increased if the pressure of the working medium 24 in the circuit as well as the acoustic intensity of the acoustic source 38 are varied so that they rise and fall over time between a minimum value and a maximum value, i.e. periodically, in which case the change in pressure is effected in the opposite cycle of the change in acoustic intensity. The change in the rising and falling values of the pressure and the sound intensity over time may be effected relatively slowly and the value of the frequency of this change is in the range of between 0.1 Hz and 10 Hz.

FIG. 6 illustrates an example of another embodiment of a gas generator 6.

The inner boundary surface 20 of the reaction chamber 19 as well as the electrode surfaces 30 and 31 together form an internal face of a spherical surface and have the effect of concentrating the sound generated by the acoustic wave 38. In other words, the boundary surface 20 and the electrode surfaces 30 and 31 together form the reflector 39 for concentrating the acoustic energy in the region of the axis 18 of the reaction chamber 19. Water flows into the reaction chamber 19 through the inlet connector 25, which is oriented at a tangent to the boundary surface 20 and perpendicular to the 18 of the reaction chamber. As a result of the inflow direction determined by the inlet connector 25, the water or working medium in the reaction chamber 19 is displaced in a rotating motion with its axis of rotation around the axis 18 of the reaction chamber 19. Consequently, a separate rotor for generating the rotating motion is not provided in this instance because the impulse of the working medium as it flows in is sufficient for this purpose.

The outlet orifice 26 of the suction lance 37 in this embodiment of the gas generator 6 illustrated as an example is provided in the form of a suction funnel 43. Adjoining the suction funnel 43 is the suction lance 37, which is also equipped with a phase separation device 44. As a result of this phase separation device 44, the liquid working medium is separated from the rising hydrogen-oxygen mixture or Brown gas containing the bubbles 36 and is thus held back in the reaction chamber 19. A throttle valve or a valve 45 is also provided in line 7 connected to the suction lance 37. By providing the valve 45 in line 7 and the pump 5 (see FIG. 1) in line 11, the reaction chamber 19 simultaneously also forms a pressure vessel, because the throttle valve or the valve 45 affords a corresponding resistance against the pressure generated by the pump 5 in the working medium or the outflowing gas.

Due to the co-operation of the electric field 35 and the rotating movement of the working medium created in the reaction chamber 19, a hydrogen-oxygen mixture or Brown gas is formed in the region of the axis 18 of the reaction chamber 19. The rate at which this gas is formed in the gas generator can be further increased by the effect of the acoustic source 38, the infrared source 40 and the magnet 41. In the embodiment illustrated as an example here, a magnet 41 is provided both in the region of the cover plate 23 and in the region of the base plate 22, as a result of which the magnetic field or the magnetic induction 42 assumes a more homogeneous course in the region of the axis 18 of the reaction chamber 19.

The gas generator 6 in this example is a constituent part of a device for converting energy and the working medium or water in this instance is not circulated in a closed circuit. The hydrogen-oxygen mixture or Brown gas generated by the gas generator 6 is used for welding. Once the hydrogen-oxygen mixture or Brown gas has been combusted in the flame of the welding torch, the resultant water vapour is given off to the ambient environment.

The embodiments illustrated as examples illustrate possible design variants of the device for converting energy, and it should be pointed out at this stage that the invention is not restricted to the various embodiments specifically illustrated and instead, various combinations of the individual embodiments with one another are possible, these possible variations being within the reach of the person skilled in this field based on the technical teaching outlined in the invention. Accordingly, all conceivable variations which can be obtained by combining individual details of the embodiments illustrated and described are possible and fall within the scope of the invention.

For the sake of good order, finally, it should be pointed out that in order to provide a clearer understanding of the device for converting energy, it and its constituent parts are illustrated to a certain extent out of scale and/or on an enlarged scale and/or on a reduced scale.

The underlying objective and the solutions proposed by the invention may be found in the description.

Above all, the individual embodiments of the subject matter illustrated in FIGS. 1; 2; 3; 4; 5 and 6 may be construed as independent solutions proposed by the invention in their own right. The objectives and associated solutions proposed by the invention may be found in the detailed descriptions of these drawings.

### LIST OF REFERENCE NUMBERS

1 Heating device 26 Outlet orifice
2 Heat generator 27 Anode
3 Heat exchanger 28 Cathode
4 Pressure vessel 29 Electrode
5 Pump 30 Electrode surface
6 Gas generator 31 Electrode surface
7 Line 32 Rotor
8 Line 33 Rotations axis
9 Line 34 Angular velocity
10 Line 35 Electric field
11 Line 36 Bubble
12 Network device 37 Suction lance
13 Control system 38 Acoustic source
14 Fan 39 Reflector
15 Temperature sensor 40 Infrared source
16 Temperature sensor 41 Magnet
17 Sintered material 42 Induction
18 Axis 43 Suction funnel
19 Reaction chamber 44 Phase separation device
20 Boundary surface 45 Valve
21 Jacket
22 Base plate
23 Cover plate
24 Working medium
25 Inlet connector

1-34. (canceled)

35. Device for converting energy comprising a gas generator (6) for generating a hydrogen-oxygen mixture or Brown gas with a reaction chamber (19), in which electrodes (29) are disposed, wherein the reaction chamber (19) is of a rotationally symmetrical shape with respect to an axis (18), and at least certain regions of the inner boundary surfaces (20) of the reaction chamber (19) in the region of a jacket (21) of the reaction chamber (19) are formed by inner electrode surfaces (30, 31) of the electrodes (29) of the gas generator (6), wherein a rotor (32) with a rotation axis (33) is provided in the gas generator (6) and the rotation axis (33) is oriented coaxially with the axis (18) of the reaction chamber (19).

36. Device as claimed in claim 35, wherein at least one inlet connector (25) for a working medium (24) is provided in the jacket (21), oriented at a tangent with respect to the jacket (21) of the reaction chamber (19).

37. Device as claimed in claim 36, wherein the rotor (32) is designed to generate a rotation with an angular velocity (34) in a range of from 10 s−1 to 25 s−1.

38. Device as claimed in claim 35, wherein an outlet orifice (26) is provided in a base plate (22) and/or cover plate (23) closing off the reaction chamber (19) and the outlet orifice (26) is disposed coaxially with the axis (18) of the reaction chamber (19).

39. Device as claimed in claim 38, wherein the outlet orifice (26) is provided in the form of a suction lance (37) which is displaceable parallel with the direction of the axis (18) of the reaction chamber (19).

40. Device as claimed in claim 38, wherein the outlet orifice (26) is provided in the form of a suction funnel (43).

41. Device as claimed in claim 39, wherein a phase separation device (44) is provided in the suction lance (37).

42. Device as claimed in claim 38, wherein a throttle valve or a valve (45) is disposed in a line (7) connected to the outlet orifice (26) and the reaction chamber (19) is provided in the form of a pressure vessel.

43. Device as claimed in claim 35, wherein the gas generator (6) is provided with an acoustic source (38).

44. Device as claimed in claim 43, wherein the acoustic source (38) is designed to generate sound at a frequency in a range of from 25 kHz to 55 kHz, preferably from 38.5 kHz to 41.5 kHz, more preferably 40.5 kHz.

45. Device as claimed in claim 43, wherein the acoustic source (38) is oriented coaxially with the axis (18) of the reaction chamber (19).

46. Device as claimed in claim 43, wherein at least a part-region of the inner boundary surface (20) of the reaction chamber (19) is shaped as a reflector (39) for concentrating the sound.

47. Device as claimed in claim 35, wherein the gas generator (6) is provided with an IR source.

48. Device as claimed in claim 35, wherein the gas generator (6) is provided with a magnet (41).

49. Device as claimed in claim 48, wherein a magnetic field direction of the magnet in the region of the axis (18) of the reaction chamber (19) is oriented anti-parallel with respect to a direction of an angular velocity (34) of the rotor (32).

50. Device as claimed in 35, wherein a pressure vessel (4) is provided for the working medium (24).

51. Device as claimed in claim 35, wherein it is designed as a heating device (1) with a heat generator (2) and an interior of the heat generator (2) is provided with a sintered material (17).

52. Device as claimed in claim 51, wherein the gas generator (6), the heat generator (2), a heat exchanger (3), the pressure vessel (4) and a pump (5) are connected to one another to form a closed circuit for the working medium (24).

53. Device as claimed in claim 52, wherein a fan (14) is provided on the heat exchanger (3) for feeding heat away from the heat exchanger (3).

54. Device as claimed in claim 35, wherein a control system (13) is provided for controlling the operating mode.

55. Device as claimed in claim 54, wherein the control system (13) is designed to run an automatic control.

56. Method of converting energy using a hydrogen-oxygen mixture or Brown gas, wherein a working medium (24) or water is fed into a reaction chamber (19) of a rotationally symmetrical shape with respect to an axis (18), and an electric field (35) is applied between electrodes (29), and an electric field direction is oriented perpendicular to the axis (18) of the reaction chamber (19) and the water is displaced in rotation, and a rotation axis (33) of the water is oriented coaxially with the axis (18) of the reaction chamber (19) and the hydrogen-oxygen mixture or Brown gas formed in the region of the axis (18) of the reaction chamber (19) is fed out of the reaction chamber (19) and the hydrogen-oxygen mixture or Brown gas is recombined to form water.

57. Method as claimed in claim 56, wherein the water and/or Brown gas in the reaction chamber (19) is exposed to a magnetic field, and a magnetic induction (42) in the region of the axis (18) of the reaction chamber (19) is oriented anti-parallel with respect to the direction of the angular velocity (34).

58. Method as claimed in claim 56, wherein the water and/or Brown gas is exposed to acoustic energy in the reaction chamber (19).

59. Method as claimed in claim 56, wherein the water and/or Brown gas is exposed to IR radiation in the reaction chamber (19).

60. Method as claimed in claim 56, wherein the water and Brown gas are conveyed in a closed circuit.

61. Method as claimed in claim 56, wherein an angular velocity (34) of the rotation of the water in the reaction chamber (19) is periodically varied.

62. Method as claimed in claim 56, wherein a pressure of the working medium (24) in the circuit is periodically varied.

63. Method as claimed in claim 56, wherein an acoustic intensity of an acoustic source (38) in the reaction chamber (19) is periodically varied.

64. Method as claimed in claim 63, wherein the periodic variation in the pressure of the working medium (24)
takes place in an opposite phase from the periodic variation of the acoustic intensity of the acoustic source (38)

65. Method as claimed in claim 56, wherein the value of a frequency of the periodic variation in the pressure of the working medium (24) and/or the acoustic intensity of the acoustic source (38) and/or the angular velocity (34) is selected from a range of between 0.1 Hz and 10 Hz.

66. Method as claimed in claim 56, wherein the recombination of the hydrogen-oxygen mixture or Brown gas takes place in a heat generator (2) and the heat generated as a result is fed away with the water.

67. Method as claimed in claim 66, wherein the Brown gas is fed through a sintered material (17) in the heat generator (2).
